(19) United States
(12) Patent Application Publication
(10) Pub. No.: US 2015/0073831 A1
(43) Pub. Date: Mar. 12, 2015

(54) EVALUATING POPULATION INDICATED FOR MEDICAL THERAPIES

(71) Applicant: Medtronic, Inc., Minneapolis, MN (US)

(72) Inventors: Meredith S. Seaborn, Minneapolis, MN (US); David L. Mackmiller, St. Paul, MN (US); Joseph E. Fleming, North Oaks, MN (US); Philia Hiotis, Perroy (CH)

(73) Assignee: Medtronic, Inc.

(21) Appl. No.: 14/482,468

(22) Filed: Sep. 10, 2014

Related U.S. Application Data
(60) Provisional application No. 61/876,591, filed on Sep. 11, 2013.

(51) Int. Cl. G06F 19/00; G06Q 40/00

(52) U.S. Cl. CPC G06F 19/3443; G06F 19/322; G06Q 40/12
USPC 705/3

(57) ABSTRACT

A method may include, receiving, by a computer system, indications of a plurality of attributes associated with applicable individuals, wherein each respective one of the applicable individuals is a member of a human population and is a potential user of a medical therapy. The method may further include, for each respective attribute of the plurality of attributes, receiving, by the computer system, a respective indication of a prevalence of the respective attribute, and estimating, by the computer system, based on the indications of the prevalence of the respective attributes, a number of applicable individuals. The method may also include outputting, by the computer system, the estimate of the number of the applicable individuals.

This application claims the benefit of U.S. Provisional Patent Application No. 61/876,591, filed Sep. 11, 2013, the entire content of which is incorporated by reference.

### SUMMARY

This disclosure describes techniques for evaluating a population indicated for a medical therapy. The disclosed techniques may be used to guide product development and/or market development of a medical therapy, for example, by estimating potential revenues for a medical therapy. In some examples, the disclosed techniques may also be used to estimate populations indicated for different medical therapies in development using standard techniques. The comparison may be useful for resource allocation and prioritization of medical therapies in development.

In one example, this disclosure is directed to a method comprising receiving, by a computer system, indications of a plurality of attributes associated with applicable individuals, wherein each respective one of the applicable individuals is a member of a human population and is a potential user of a medical therapy. The method further includes, for each respective attribute of the plurality of attributes, receiving, by the computer system, a respective indication of a prevalence of the respective attribute, and estimating, by the computer system, based on the indications of the prevalence of the respective attributes, a number of applicable individuals. The method also includes outputting, by the computer system, the estimate of the number of the applicable individuals.

In another example, this disclosure is directed to a computer system-readable storage medium (e.g., a non-transitory computer system-readable storage medium) that stores computer system-executable instructions that, when executed, configure a computer system to receive indications of a plurality of attributes associated with applicable individuals, wherein each respective one of the applicable individuals is a member of a human population and is a potential user of a medical therapy; for each respective attribute of the plurality of attributes, receive a respective indication of a prevalence of the respective attribute; estimate, based on the indications of the prevalence of the respective attributes, a number of applicable individuals; and output the estimate of the number of the applicable individuals.

In another example, this disclosure is directed to a computer system comprising one or more processors configured to receive indications of a plurality of attributes associated with applicable individuals, wherein each respective one of the applicable individuals is a member of a human population and is a potential user of a medical therapy; for each respective attribute of the plurality of attributes, receive a respective indication of a prevalence of the respective attribute; estimate, based on the indications of the prevalence of the respective attributes, a number of applicable individuals; and present the estimate of the number of applicable individuals to a user.

The details of one or more examples of the techniques are set forth in the accompanying drawings and the description below. Other features, objects, and advantages of the techniques will be apparent from the description, drawings, and claims.

### BRIEF DESCRIPTION OF DRAWINGS

FIG. 1 illustrates a network including a computer system for determining the identity and/or number of individuals who may utilize a medical therapy.

FIG. 2 is a flowchart illustrating example techniques for determining the identity and/or number of individuals who may utilize a medical therapy.

FIG. 3 illustrates a setup page of a user interface, the setup page being configured to receive user inputs for determining the identity and/or number of individuals who may utilize a medical therapy.

FIG. 4 illustrates an indication tree page of a user interface, the indication tree page being configured to present, based on user inputs, an indication tree that represents an estimate of a number of individuals who may utilize a medical therapy.

FIG. 5 illustrates a sources page of a user interface, the sources page being configured to receive and display sources of information used in determining the identity and/or number of individuals who may utilize a medical therapy.

FIG. 6 is a block diagram of an example configuration of a computer system that may be used to determine the identity and/or number of individuals who may utilize a medical therapy.

### DETAILED DESCRIPTION

Techniques for determining a number of applicable individuals indicated for a medical therapy as disclosed herein may be used to guide development of a medical therapy, for example, by estimating potential revenues for a medical therapy in development. In some examples, the disclosed techniques may also be used to compare populations indicated for different medical therapies in development using standard techniques. The comparison may be useful for resource allocation and prioritization of medical therapies in development as well as marketing and distribution of preexisting medical therapies across multiple jurisdictions.

Furthermore, product development and market development for medical therapies, including but not limited to, diagnostic therapies, pharmaceuticals and associated treatments, and medical devices and associated treatments, may be unpredictable across jurisdictional boundaries. For example, the proportion of patients within a population indicated for a medical therapy may vary according to environmental, ethnic or socioeconomic factors. As these examples illustrate, predicting indicated populations for a medical therapy prior to product development and/or market development across multiple jurisdictions can be a complex process.

Techniques for identifying applicable individuals as disclosed herein may be applied to any medical therapy or combination of medical therapies. In different examples, such medical therapies may include surgical treatments, pharmaceutical treatments, medical device implants and treatments, physical therapies, physiological therapies, biological therapies and any combination thereof.

The attached drawings illustrate examples. Elements indicated by reference numbers in the attached drawings correspond to elements indicated by like reference numbers in the following description. In the attached drawings, stacked elements may indicate the presence of one or more similar elements. In this disclosure, elements having names that start with ordinal words (e.g., “first,” “second,” “third,” and so on) do not necessarily imply that the elements have a particular order. Rather, such ordinal words may merely be used to refer to different elements of a same or similar type.

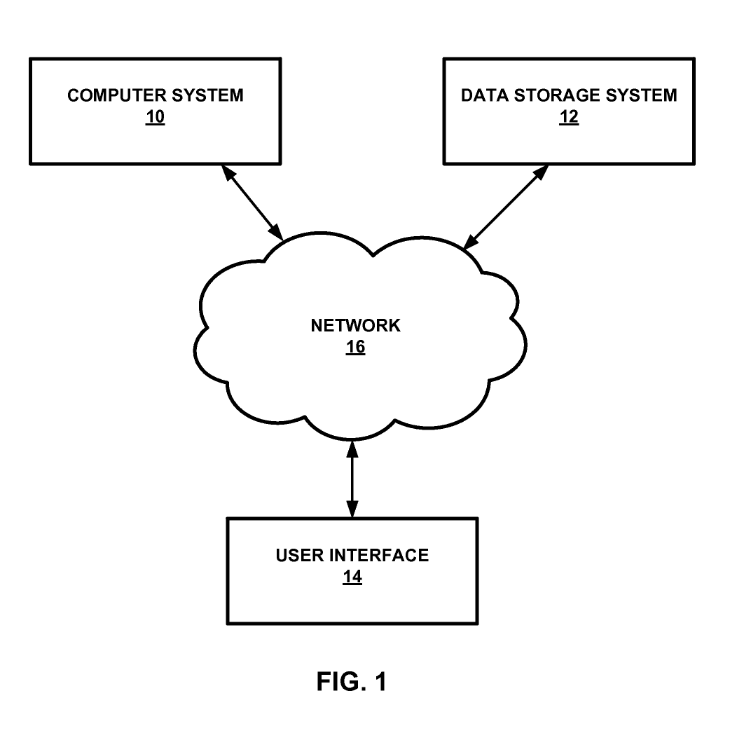

FIG. 1 illustrates a network including a computer system for determining the identity and/or number of individuals who may utilize a medical therapy. The network shown in FIG. 1 includes computer system 10, data storage system 12, user interface 14 and network 16. Network 16 may serve to communicatively couple each of computer system 10, data storage system 12 and user interface 14 to one another. In different examples, network 16 may represent a computer bus, a local area network (LAN), a virtual private network (VPN), the Internet, a combination thereof or any other network.

In accordance with the techniques described herein, computer system 10 may receive, via user interface 14, user inputs for determining the number of applicable individuals. The applicable individuals may be individuals, within a human population, who may utilize a medical therapy. In different examples, such user inputs may include indications of a plurality of attributes within a human population associated with applicable individuals, as well as indications of the prevalence of each attribute. The prevalence of an attribute may be the prevalence (e.g., percentage) of individuals in the human population having the attribute. In some examples, computer system 10 may further receive user inputs of sources associated with the indications of the prevalence of each attribute. An individual may be associated with an attribute if the individual has the attribute. These user inputs may then be received by computer system 10 and may optionally be stored in data storage system 12.

In some examples, user interface 14 is a graphical user interface. In such examples, a computer system (e.g., computer system 10 or another computer system) outputs user interface 14 for display on a display device, such as a computer monitor, computer display, or touchscreen. Outputting user interface 14 for display may comprise outputting information that a display device may use to display user interface 14. A user may interact with user interface 14 using various input devices, such as keyboards, computer mice, and touchscreens. When a user interacts with user interface 14, a computer system (e.g., computer system 10 or another computer system) may receive an indication of user input associated with user interface 14. Such user input may include keyboard input, mouse movement and click input, touch input, and/or other types of user input.

While computer system 10 may receive information for determining the number of applicable individuals directly from a user, in other examples, computer system 10 may access the information for determining the number of applicable individuals from data storage system 12. In this manner, computer system 10 may receive some or all the information for determining the number of applicable individuals from user interface 14, data storage system 12, and/or other sources.

Following receipt of the information for determining the number of applicable individuals, computer system 10 evaluates the information for determining the number of applicable individuals to produce one or more estimates of the number of applicable individuals.

After producing the estimate of the number of applicable individuals, computer system 10 may present the estimate of the number of applicable individuals to a user via user interface 14. The estimate may be used to guide development of a medical therapy as well as distribution and marketing strategies for commercially release medical therapies, for example, by estimating potential revenues for a medical therapy. In some examples, the estimate may also be used to compare populations indicated for different medical therapies in development using standard techniques. The comparison may be useful for resource allocation and prioritization of medical therapies in development or potential development as well as distribution and marketing strategies for commercially release medical therapies.

In the same or different examples, computer system 10 may store the estimate of the number of applicable individuals for later retrieval by a user. The computer system may optionally store all or some of the information for determining the number of applicable individuals as well as sources for the information when available. This may allow users to evaluate, update, and verify the information for determining the number of applicable individuals at a future time, for example, once additional information becomes available.

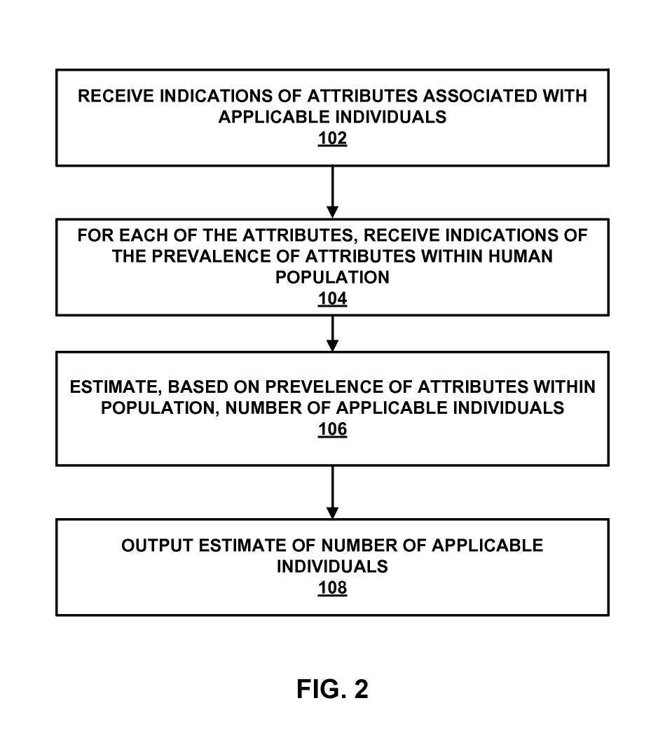

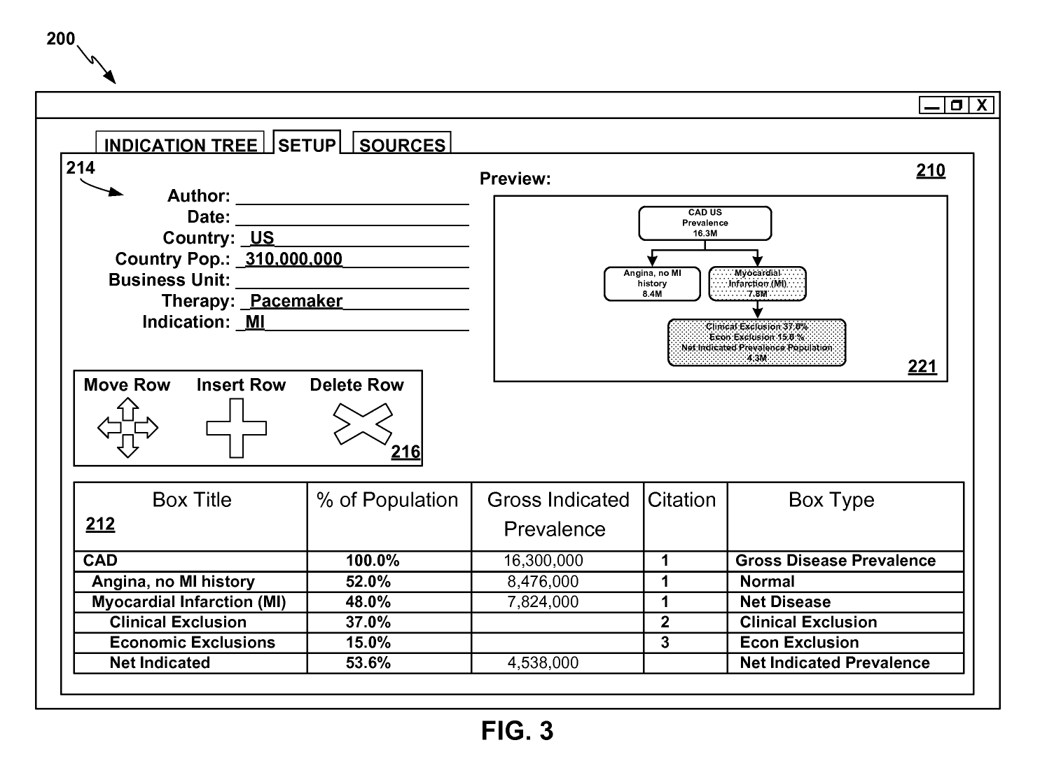

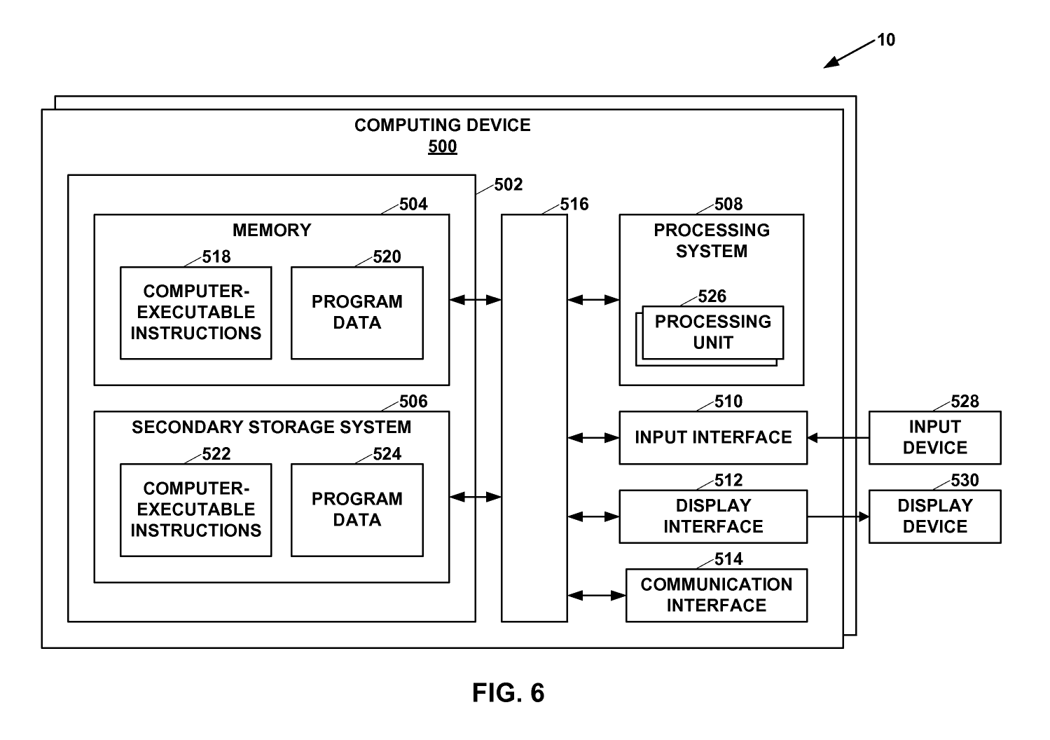

FIG. 2 is a flowchart illustrating example techniques for determining the identity and/or number of individuals who may utilize a medical therapy, referred to herein as applicable individuals. In some examples, the techniques of FIG. 2 may be implemented with a user interface, such as user interface 200 of FIGS. 3-5. As shown in the example of FIG. 2, a computer system, such as computer system 10 (FIG. 6), may receive indications of a plurality of attributes associated with applicable individuals (102). The applicable individuals may be individuals, within the human population, who may utilize a medical therapy. In other words, each respective one of the applicable individuals is a member of a human population and is a potential user of a medical therapy. The computer system may also receive an indication of a total number of individuals within the human population, e.g., as illustrated in header 214 of setup page 210 (FIG. 3). In the example of header 214 of setup page 210, the total number of individuals within the human population represents an estimate of a number of individuals who have a medical condition, in this case Coronary Artery Disease (CAD), associated with the medical therapy.

The computer system further receives, for each respective attribute of the plurality of attributes, a respective indication of a prevalence of the respective attribute (104). In some examples, the computer system may first query one or more users to input each of the indications of a plurality of attributes within a human population associated with individuals within the human population who may utilize a medical therapy as well as to input the indications of the prevalence of the attributes via a user interface. For instance, computer system 10 may query one or more users to input the indications of the plurality of attributes with the human population associated with the applicable individuals. For each respective attribute of the plurality attributes, computer system 10 may query the one or more users to input the indication of the prevalence of the respective attribute. In some examples, the computer system may receive each of the indications of a plurality of attributes within a human population associated with individuals within the human population who may utilize a medical therapy as well as the indications of the prevalence of the attributes from a user via a user interface or the computer system may retrieve some or all of the indications of a plurality of attributes within a human population associated with individuals within the human population who may utilize a medical therapy as well as the indications of the prevalence of the attributes from a data storage system, such as data storage system 12 (FIG. 1).

Following receipt of the indications of a plurality of attributes associated with the applicable individuals as well as the indications of the prevalence of each of the attributes, computer system 10 may estimate, based at least in part on the indications of the prevalence of each of the plurality of attributes, a number of applicable individuals (106).

In some examples, applicable individuals may be individuals within a human population who may use (or may be treated using) the medical therapy. In other words, the number of applicable individuals may represent the number of individuals within the human population who may benefit from the medical therapy. In such examples, estimating the number of applicable individuals may include estimating, by the computer system, the identity and/or number of individuals within the human population who have a first attribute of a plurality of attributes. In addition, for each subsequent attribute (i.e., each attribute following the first attribute) within the plurality of attributes, the computer system may reduce the estimate of the identity and/or number of individuals within the human population who have each attribute previously accounted for, by an estimated prevalence of the subsequent attribute within a population of individuals who have each attribute previously accounted for. In other words, the computer system may determine, for each respective attribute in a series of attributes, an estimated number of applicable individuals that have each the respective attribute and also each attribute in the series of attributes previous to the respective attribute. In such examples, the reduced estimate following the accounting of the last attribute within the plurality of attributes may represent the estimate of the number of applicable individuals. In such examples, the indications of the prevalence of each of the plurality of attributes represents the prevalence estimates of each of the subsequent attributes within the populations of individuals who have each attribute previously accounted for. In other words, for each respective attribute within the plurality of attributes, the indication of the prevalence of the respective attribute represents the estimated prevalence of each subsequent attribute within the populations of individuals who have each attribute previously accounted for. In this manner, the prevalence estimates may discount individuals who do not have each attribute previously accounted for. The attributes previously accounted for are those that are within a dominant position of the same branch within a hierarchy of an indication tree. In some examples, for each respective attribute within the plurality of attributes, the computer system may present (i.e., output for display) the reduced estimate of the identity and/or number of individuals within the human population who have the respective attribute and each attribute previously accounted for.

However, in some examples, there may not be specific information available for the prevalence estimates of each of the subsequent attributes within the populations of individuals who have each attribute previously accounted for. In such examples, some or all prevalence estimates may represent an estimate of the prevalence of an attribute within a more general population.

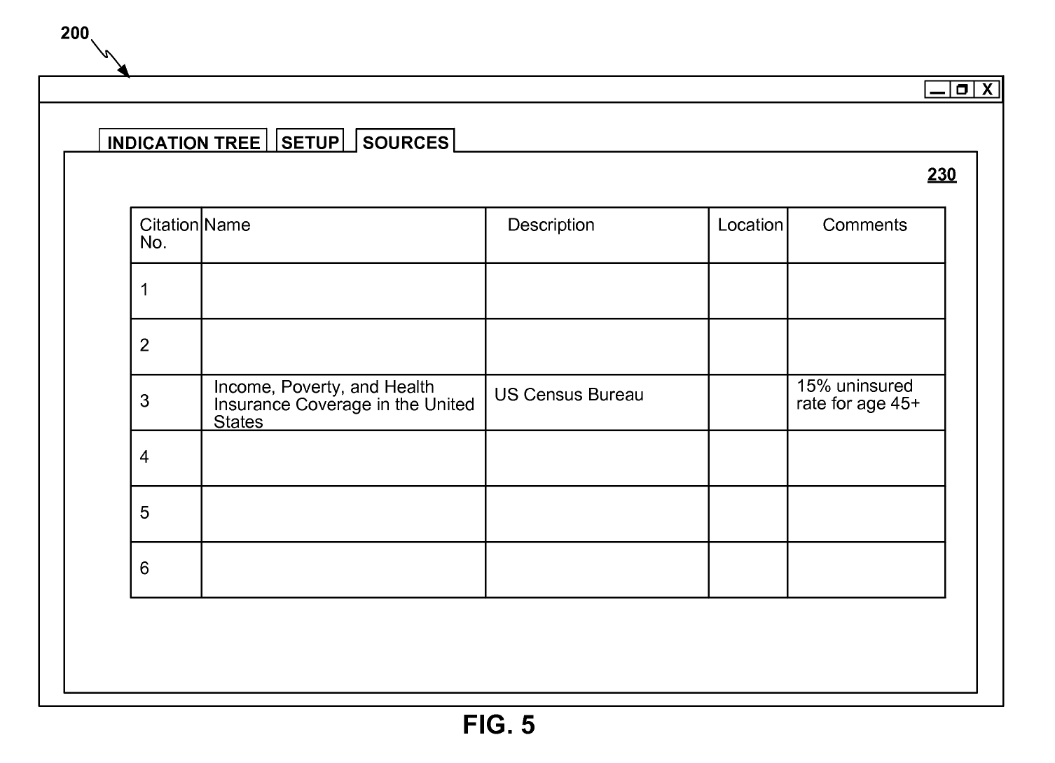

One example of a prevalence estimate that represents an estimate of the prevalence of an attribute within a more general population is illustrated in the example of FIG. 5. As shown in the example of FIG. 5 and discussed in further detail below, the prevalence of uninsured individuals over the age of 45 is used to estimate the prevalence of uninsured individuals within the gross indicated population; in this example the myocardial infarction (MI) population.

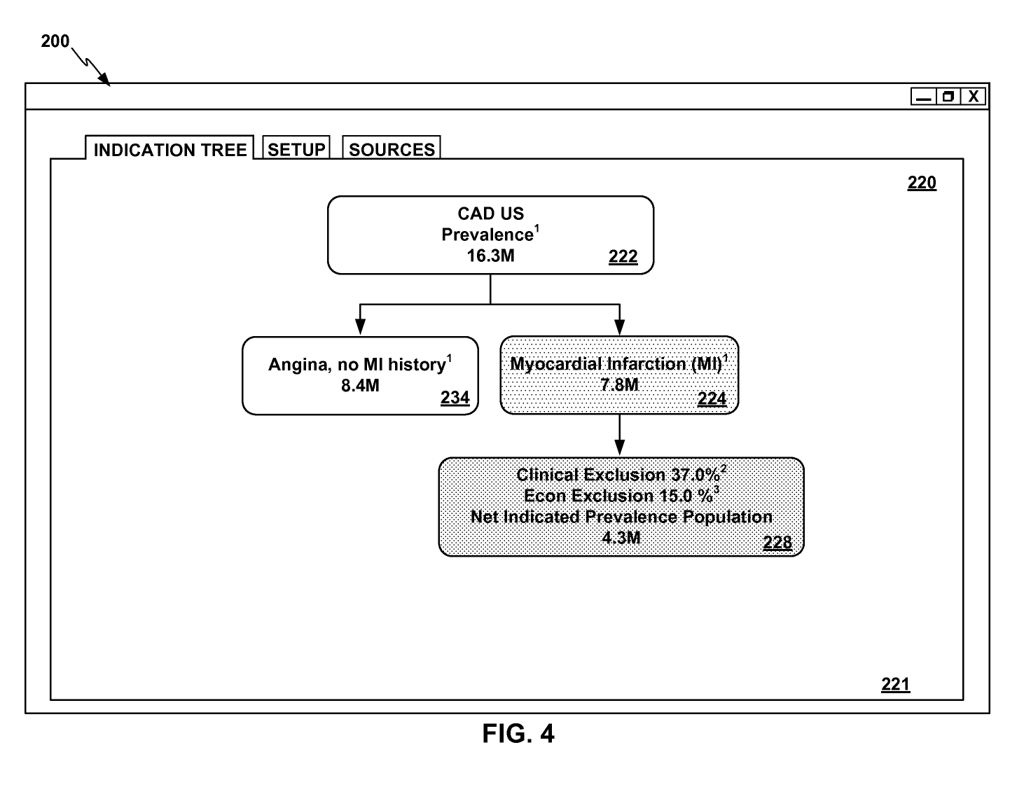

After estimating a number of applicable individuals based on the indication of the prevalence of each of the plurality of attributes, computer system 10 may output the estimate of the number of applicable individuals (108). The estimate may be used to guide development of a medical therapy, for example, by estimating potential revenues for a medical therapy in development. In some examples, the estimate may also be used to compare populations indicated for different medical therapies in development using standard techniques. The comparison may be useful for resource allocation and prioritization of medical therapies in development or potential development. In some examples, such as the example of FIG. 4, computer system 10 may output an indication tree that presents each of the plurality of attributes associated with applicable individuals within a hierarchy. Furthermore, in some examples, for each respective attribute of the plurality of attributes, computer system 10 may output, for display, a value for the respective attribute. The value for the respective attribute may be an estimate of a number of individuals that are associated with the respective attribute and all other attributes at a dominant position within the hierarchy as compared to the respective attribute.

In the same or different examples, computer system 10 may store the estimate of the number of applicable individuals on a non-transitory computer-readable medium for later retrieval by a user, computer system 10 or another computing device. For instance, computer system 10 may associate the medical therapy with the estimate of the number of the applicable individuals and may store, on a non-transitory computer-readable medium, an identification of the medical therapy and the estimate of the number of the applicable individuals.

The computer system may optionally store all or some of the information for determining the number of applicable individuals as well as sources for the information when available. For example, computer system 10 may receive sources for the information in conjunction with the information for determining the number of applicable individuals, e.g., via user interface 14. This may allow users to evaluate, update and verify the information for determining the number of applicable individuals at a future time, for example, once additional information becomes available.

FIGS. 3-5 illustrate an example user interface 200 that may be used by a computer system, such as computer system 10, configured to determine the number of applicable individuals. More specifically, FIG. 3 illustrates a setup page 210 configured to receive user inputs for determining the number of applicable individuals. FIG. 4 illustrates an indication tree page 220 that presents an indication tree representing numbers of applicable individuals. FIG. 5 illustrates a sources page 230 configured to receive and display sources of information used in determining the number of applicable individuals.

As mentioned previously, FIG. 3 illustrates setup page 210 of user interface 200. Setup page 210 is configured to receive user inputs for determining the number of applicable individuals. In particular, setup page 210 includes header 214 and table 212 to receive user inputs of information for determining the number of applicable individuals.

In particular, header 214 allows the computer system to receive a user input of the “author” of the indication tree, the “business unit” associated with the indication tree, the “date” the indication tree was created as well as the country and population associated with the indication tree. In addition, header 214 further includes labels for the therapy and the therapy indication. In the example of FIGS. 3-5, the medical therapy being evaluated is “pacemaker,” and the therapy indication is myocardial infarction (MI). Note, that the data included within FIGS. 3-5 is for illustrative purposes only and does not represent an actual evaluation of the indicated population for a pacemaker or other medical therapy.

Table 212 includes different columns that receive and/or present information associated with determining the number of applicable individuals. Within table 212, the portions in bold are those that are received by the computer system from a user. The computer system may automatically fill-in the remaining boxes based on the user inputs.

The first column within table 212 is the “Box Title” column. The Box Title column lists the labels for boxes of indication tree 221. Indication tree 221 is shown as a preview on setup page 210 as well as in a larger scale on indication tree page 220 (FIG. 4). In some examples, when the computer system receives a selection of a cell within table 212, the computer system may highlight the corresponding box within the preview of indication tree 221. As shown in the Box Title, the computer system has received user inputs for CAD, representing coronary artery disease in the first row, “Angina, no MI history,” in the second row and Myocardial Infarction (MI) in the third row. As explained in further detail below, the computer system automatically selected the remaining titles upon receiving the user selection of “Net Disease” in the “Box Type” column for the third row.

The next column of table 212 is the “Percent of Population” column. The Percent of Population column lists the numerical percent of the population who have the attribute listed in the Box Title of the same row. The numerical percents listed are either received from a user by the computer system, or automatically calculated by the computer system when possible. For example, the computer system automatically lists 100.0 percent in the first row representing the gross disease population. Then, upon receiving the user input of 52.0 percent for the second row, the computer system may automatically insert the population listed in the “Population” column for the second. In other examples, the computer system may wait for a user input for the percents in each box as each box may be divided into more than two subgroups. In some examples, the computer system may respond to a click on any of the cells in the % of Population column by presenting the total percent for the boxes that level in a status bar. For example. the computer system may display, “Boxes at this level of this branch total 52%,” in the status bar.

The next column of table 212 is the Gross Prevalence Column (i.e., the Population column). The Population column displays an estimate of the identity and/or number of individuals within the human population who have the attribute listed in the Box Title column and any other attributes previously accounted for, i.e., attributes listed above the subject attribute within the same branch of the indication tree 221. Indication tree 221 is shown in detail on indication tree page 220 of user interface 200 as illustrated in FIG. 4. For clarity, the description of the “Population” column of table 212 is described with reference to indication tree 221 in FIG. 4.

For example, box 222 of indication tree 221 represents the user-entered CAD population of approximately 16,300,000 in the United States. This attribute is the dominant attribute for the indication tree, meaning each estimated population within the boxes of indication tree 221 is associated with CAD and residency in the United States. The gross disease population row allows the computer system to receive a user input of a number of individuals having a general attribute that may qualify the individuals as candidates for a medical therapy. As shown in header 214, the gross disease population in this example is 16,300,000 individuals. As indicated in the first row of table 212, the gross disease population number represents an estimate of individuals within the United States who have CAD. As discussed in further detail below, not everyone who has CAD is actually a suitable candidate for the medical therapy. Thus, the gross disease population is reduced according to the additional factors listed in table 212 to estimate of the number of applicable individuals. The computer system calculates the populations listed in the remaining rows based on the user inputs in the Percent of Population column as well as the user-entered population listed in the gross disease population row.

According to the second row of table 212, 52 percent of the CAD population in the United States has experienced angina, with no history of MI. As represented by table 212 and indication tree 221, this population is excluded from indication for the medical therapy. Thus, as listed in the third row of table 212, the remaining 48 percent of the CAD population in the United States, which has experienced a MI, is indicated for the medical therapy. Thus, the MI population within the United States is forty-eight percent of the gross disease population of CAD. Forty-eight percent of 16,300,000 is approximately 7,824,000, as shown in the Population column of the second row of table 212, and as represented by box 224 of indication tree 221.

Any number of factors may be used to estimate the net disease population indicated the identity and/or number of individuals for a therapy. These factors will vary according to the medical therapy being evaluated. Such factors may include patient attributes such as age, blood pressure, weight, medical history, gender and numerous other factors. In some examples, the factors may be based on the premise that such patients may not benefit from the medical therapy being evaluated or that the medical therapy being evaluated may pose too much of a risk to such patients or otherwise provide an unsuitable expected efficacy for such patients. In the same or different examples, the factors may be based on the premise that such patients may be better candidates for an alternative medical therapy. In the example of table 212 and indication tree 221, the only factor represented is whether the patient has experienced MI. In other examples, multiple factors may be listed within table 212 and indication tree 221. Each factor would represent a further reduction of the gross disease population in order to estimate the net disease population indicated for a therapy.

The last column in table 212 is the “Box Type” column. The “Box Type” column displays the style of the box within indication tree 221 that represents the attribute listed in the Box Title column. In the first row, the style will usually be “Gross Disease Prevalence,” representing the number of people with a given condition.

The style may be selected by the user and received by the computer system. The default style is “Normal,” and the user can optionally select “Gross Indicated Prevalence” to represent the box as the Gross Indicated Prevalence. The computer system receives the user style selection and updates the style of the box within indication tree according to the user's selection. As shown in table 212, computer system 10 received an indication of a user selection of the “Gross Indicated Prevalence” style for row three. Thus, box 224 of indication tree 221 (FIG. 4) is shown in the “Gross Indicated Prevalence” style. The Gross Indicated Prevalence style represents the number of people with the given condition who are indicated for the therapy.

Following the selection of the “Gross Indicated Prevalence” style, the computer system creates the remaining three rows titled, “Clinical Exclusions,” “Economic Exclusions,” and “Net Indicated Prevalence.” Clinical Exclusions represents the percentage of individuals within the Net Disease population who are not suitable candidates for receiving the medical therapy based on physiological attributes that are unrelated to the disease state. Such attributes may include age, weight, disability, separate disease or other attributes. The computer system enters default values of zero percent in the Percent of Population column in the Clinical Exclusions and Economic Exclusions rows. The computer system may then receive different values for the Percent of Population column in the Clinical Exclusions and Economic Exclusions rows from a user. In the example of FIG. 3, the user has entered 37.0 percent for the Clinical Exclusions and 15.0 percent for the Economic Exclusions. Based on these values, the computer system calculated a Net Indicated Prevalence of approximately 4,538,000, which is listed in row six of table 212 and presented in box 228 of indication tree 221.

Economic Exclusions represent the prevalence of patients who are indicated for a therapy, but are unable to pay for the therapy. In one example, these may represent uninsured patients. In some jurisdictions, health insurance may not be common and economic exclusions may represent the prevalence of patients who are both uninsured and unable to afford the therapy being evaluated. Economic exclusions may vary greatly between different jurisdictions.

In the example of FIG. 4, the Gross Indicated Prevalence within the United States is further reduced by fifteen percent according to economic exclusions (e.g., uninsured patients) to estimate the net indicated population for the therapy within the MI population within the United States, giving a net indicated population for the therapy within the MI population within the United States of 4,538,000 as shown in the sixth row of table 212, and as represented by box 228 of indication tree 221, which is located at a termination of a branch of indication tree 221. Thus, in some examples, computer system 10 may output, for display, the estimate of the number of applicable individuals within a box of an indication tree at a termination of a branch of the indication tree. In some examples, the box may represent the applicable individuals. In this manner, the net indicated population for the therapy within the MI population within the United States represents the identity and/or number of individuals within the MI population who may both benefit from and access the therapy. Thus, in some examples, computer system 10 estimates the identity and/or number of individuals within the human population who may benefit from a medical therapy. In some such examples, computer system 10 may reduce the number of applicable individuals by a prevalence of individuals are able to access the medical therapy within the population who may benefit from the medical therapy to estimate a number of individuals within the human population who may benefit from the medical therapy and are able to access the medical therapy. Furthermore, in such examples, computer system 10 may output an indication of the entity and/or number of individuals within the human population who may benefit from the medical therapy and are able to access the medical therapy. In some examples, computer system 10 may output an indication of the number of applicable individuals represents an identity and/or a number of individuals within the human population who may benefit from the medical therapy and are able to access the medical therapy.

In some examples, the percent values used to calculate the Gross Indicated Prevalence based on the gross disease population may be consistent across multiple jurisdictions. In such examples, creating a new indication tree for a new jurisdiction may be simplified by maintaining the percent values used to calculate the net disease population based on the gross disease population. Similarly, the clinical exclusion percent value may also be consistent across multiple jurisdictions.

Indication tree 221 represents the net indicated prevalence using the “Net Indicated Prevalence” style as shown in the Box Type column of table 212 and represented in box 228 of indication tree 221.

As demonstrated by indication tree 221, the population estimate within the box of each respective attribute represents an estimate of a number of individuals associated with that respective attribute as well as each attribute having a dominant position within the hierarchy of indication tree 221. For example, boxes 224 and 222 are dominant relative to box 228. Therefore, the population estimates of box 228 represents an estimate of a number of individuals associated with each of the attributes represented by boxes 224 and 222 in addition to the attribute associated with box 228.

Indication tree 221 includes a variety of factors that may be used to identify applicable individuals including, residency (box 222), disease (boxes 222, 224), clinical factors (box 228) and economic factors (boxes 228). Any number of other factors may be used to identify applicable individuals in addition to or alternatively to the factors provided in the example of indication tree 221. In different examples, reducing the net disease population to estimate the Gross Indicated Prevalence may require including more than one factor.

Within table 212, the “Citation No.” column follows the “Population” column. The “Citation No.” column displays the reference number(s) for the data associated with the attribute listed in the Box Title column. For example, the data may represent the prevalence of the attribute listed in the Box Title column in the relevant population. Thus, in some examples, computer system 10 may receive, for each respective attribute of a plurality of attributes, an indication of a source that provides the indication of the prevalence of the respective attribute. In the example of user interface 200, the citations are listed on the sources page 230 (FIG. 5). In some examples, the computer system may indent the box titles listed within the Box Title column according to the hierarchy of indication tree 221, such that attributes located lower in the hierarchy of indication tree 221 are indented relatively further within the Box Title column.

Sources page 230 is configured to receive and display sources of information used in determining the identity and/or number of individuals who may utilize the medical therapy being evaluated using the user interface 200. Sources page 230 illustrates an example reference for citation number 3: a US Census Bureau report that indicates fifteen percent of the population in the United States over the age of 45 is uninsured. Generally, sources page 230 should list references for all of the information within table 212.

In the example reference for citation number 3, while the population in the United States over the age of 45 may not be precisely representative of the CAD population within the United States, this information may represent the best available information relating to the prevalence of insurance within the CAD population within the United States. In this example, if additional information is found relating to the prevalence of insurance within the CAD population within the United States, a user may quickly compare the additional information to the source of information listed on the sources page 230. If the user believes the additional information relating to the prevalence of insurance within the CAD population within the United States is more accurate, the user may then update the information within table 212 to reflect the additional information. The computer system would receive the additional information from the user and update table 212 according to the user input. The user may then also update the reference information listed on sources page 230. Again, the computer system would receive the updated reference information from the user and sources page 230 according to the user input.

Navigation box 216 allows computer system 10 to receive indications of user input to add, delete and modify the location of rows within table 212. Addition, deletion and modification of rows within table 212 may cause changes to indication tree 221. For example, deletion of a row within table 212 may result in the deletion of the corresponding box within indication tree 221. As another example, moving a row may move the corresponding box up or down a single branch within indication tree 221 and/or move the corresponding box to a different branch within indication tree 221. The presentation of indication tree 221 within setup page 210 may allow a user to see a preview of the results of any changes inputted using navigation box 216.

FIG. 6 is a block diagram of an example configuration of a computer system 10, which may be used to determine the identity and/or number of individuals who may utilize a medical therapy, e.g., by implementing user interface 200, as described with respect to FIGS. 3-5. In the example of FIG. 6, computer system 10 comprises a computing device 500 and one or more other computing devices.

Computing device 500 is a physical device that processes information. In the example of FIG. 6, computing device 500 comprises a data storage system 502, a memory 504, a secondary storage system 506, a processing system 508, an input interface 510, a display interface 512, a communication interface 514, and one or more communication media 516. Communication media 516 enable data communication between processing system 508, input interface 510, display interface 512, communication interface 514, memory 504, and secondary storage system 506. Computing device 500 can include components in addition to those shown in the example of FIG. 6. Furthermore, some computing devices do not include all of the components shown in the example of FIG. 6.

A computer system-readable medium may be a medium from which a processing system can read data. Computer system-readable media may include computer system storage media and communications media. Computer system storage media may include physical devices that store data for subsequent retrieval. Computer system storage media are not transitory. For instance, computer system storage media do not exclusively comprise propagated signals. Computer system storage media may include volatile storage media and non-volatile storage media. Example types of computer system storage media may include random-access memory (RAM) units, read-only memory (ROM) devices, solid state memory devices, optical discs (e.g., compact discs, DVDs, Blu-ray discs, etc.), magnetic disk drives, electrically-erasable programmable read-only memory (EEPROM), programmable read-only memory (PROM), magnetic tape drives, magnetic disks, and other types of devices that store data for subsequent retrieval. Communication media may include media over which one device can communicate data to another device. Example types of communication media may include communication networks, communications cables, wireless communication links, communication buses, and other media over which one device is able to communicate data to another device.

Data storage system 502 may be a system that stores data for subsequent retrieval. In the example of FIG. 6, data storage system 502 comprises memory 504 and secondary storage system 506. Memory 504 and secondary storage system 506 may store data for later retrieval. In the example of FIG. 6, memory 504 stores computer system-executable instructions 518 and program data 520. Secondary storage system 506 stores computer system-executable instructions 522 and program data 524. Physically, memory 504 and secondary storage system 506 may each comprise one or more computer system storage media.

Processing system 508 is coupled to data storage system 502. Processing system 508 may read computer system-executable instructions from data storage system 502 and executes the computer system-executable instructions. Execution of the computer system-executable instructions by processing system 508 may configure and/or cause computing device 500 to perform the actions indicated by the computer system-executable instructions. For example, execution of the computer system-executable instructions by processing system 508 can configure and/or cause computing device 500 to provide Basic Input/Output Systems (BIOS), operating systems, system programs, application programs, or can configure and/or cause computing device 500 to provide other functionality.

Processing system 508 may read the computer system-executable instructions from one or more computer system-readable media. For example, processing system 508 may read and execute computer system-executable instructions 518 and 522 stored on memory 504 and secondary storage system 506.

Processing system 508 may comprise one or more processing units 526. Processing units 526 may comprise physical devices that execute computer system-executable instructions. Processing units 526 may comprise various types of physical devices that execute computer system-executable instructions. For example, one or more of processing units 526 may comprise a microprocessor, a processing core within a microprocessor, a digital signal processor, a graphics-processing unit, or another type of physical device that executes computer system-executable instructions.

Input interface 510 may enable computing device 500 to receive input from an input device 528. Input device 528 may comprise a device that receives input from a user. Input device 528 may comprise various types of devices that receive input from users. For example, input device 528 may comprise a keyboard, a touch screen, a mouse, a microphone, a keypad, a joystick, a brain-computer system interface device, or another type of device that receives input from a user. In some examples, input device 528 is integrated into a housing of computing device 500. In other examples, input device 528 is outside a housing of computing device 500. In some examples, input device 528 may receive information used in determining the identity and/or number of individuals who may utilize a medical therapy and/or other types of data as described above.

Display interface 512 may enable computing device 500 to display output on a display device 530. Display device 530 may be a device that presents output. Example types of display devices include printers, monitors, touch screens, display screens, televisions, and other types of devices that display output. In some examples, display device 530 is integrated into a housing of computing device 500. In other examples, display device 530 is outside a housing of computing device 500. In some examples, display device 530 may present the different pages of user interface 200 as described above.

Communication interface 514 may enable computing device 500 to send and receive data over one or more communication media. Communication interface 514 may comprise various types of devices. For example, communication interface 514 may comprise a Network Interface Card (NIC), a wireless network adapter, a Universal Serial Bus (USB) port, or another type of device that enables computing device 500 to send and receive data over one or more communication media. In some examples, communication interface 514 may receive information used in determining the identity and/or number of individuals who may utilize a medical therapy as described above. Furthermore, in some examples, communication interface 514 may output information used in determining the identity and/or number of individuals who may utilize a medical therapy and/or estimates of the identity and/or number of individuals within the human population who may utilize the medical therapy as described above.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer system-readable medium, such as a computer system-readable storage medium, containing instructions. Instructions embedded or encoded in a computer system-readable medium, including a computer system-readable storage medium, may cause one or more programmable processors, or other processors, to implement one or more of the techniques described herein, such as when instructions included or encoded in the computer system-readable medium are executed by the one or more processors. Computer system readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer system readable media. In some examples, an article of manufacture may comprise one or more computer system-readable storage media.

The techniques described in this disclosure may provide one or more advantages. For example, an indication tree may be used define and gain consensus around a number of applicable individuals who may benefit from a therapy. The estimate of a number of applicable individuals who may benefit from a medical therapy may quantify a prevalence pool and, in turn, quantify a market opportunity associated with the medical therapy. In different examples, such a market opportunity may be associated with product developments and/or market developments. Furthermore, a deficiency of some computer systems is that some computer systems are unable to generate and output estimates of applicable individuals. The techniques of this disclosure may address these deficiencies.

Various examples have been described. These and other examples are within the scope of the following claims.

What is claimed is:

1. A method comprising:
receiving, by a computer system, indications of a plurality of attributes associated with applicable individuals, wherein each respective one of the applicable individuals is a member of a human population and is a potential user of a medical therapy;
for each respective attribute of the plurality of attributes, receiving, by the computer system, a respective indication of a prevalence of the respective attribute;
estimating, by the computer system, based on the indications of the prevalence of the respective attributes, a number of applicable individuals; and
outputting, by the computer system, the estimate of the number of the applicable individuals.

2. The method of claim 1, further comprising outputting, by the computer system, an indication tree for display, the indicating tree presenting each of the plurality of attributes associated with applicable individuals within a hierarchy.

3. The method of claim 2, wherein outputting the indication tree for display comprises, for each respective attribute of the plurality of attributes, outputting, by the computing device, for display, a value for the respective attribute, wherein the value for the respective attribute is an estimate of a number of individuals that are associated with the respective attribute and all other attributes at a dominant position within the hierarchy as compared to the respective attribute.

4. The method of claim 2, wherein outputting the estimate of the number of the applicable individuals comprises outputting, by the computing device, for display, the estimate of the number of the applicable individuals within a box of the indication tree at a termination of a branch of the indication tree.

5. The method of claim 1, further comprising:
associating, by the computer system, the medical therapy with the estimate of the number of the applicable individuals; and
storing, by the computer system, on a non-transitory computer-readable medium, an identification of the medical therapy and the estimate of the number of the applicable individuals.

6. The method of claim 1,
wherein estimating the number of the applicable individuals comprises:
estimating the number of individuals within the human population who have a first attribute within the plurality of attributes; and
for each respective subsequent attribute within the plurality of attributes, reducing, by the computer system, an estimate of the number of individuals within the human population who have each attribute previously accounted for, by an estimated prevalence of the subsequent attribute within a population of individuals who have each attribute previously accounted for,
wherein the reduced estimate following the accounting of the last attribute within the plurality of attributes represents the estimate of the number of applicable individuals.

7. The method of claim 6, wherein, for each respective attribute of the plurality of attributes, the indication of the prevalence of the respective attribute represents the estimated prevalence of each subsequent attribute within the populations of individuals who have each attribute previously accounted for.

8. The method of claim 6, further comprising, for each respective attribute within the plurality of attributes, outputting, by the computer system, for display, the reduced estimate of the number of individuals within the human population who have the respective attribute and each attribute previously accounted for.

9. The method of claim 1, further comprising receiving, by the computer system, an indication of a total number of individuals within the human population.

10. The method of claim 9, wherein the total number of individuals within the human population represents an estimate of a number of individuals who have a medical condition associated with the medical therapy.

11. The method of claim 1, wherein the number of applicable individuals represents the number of individuals within the human population who may benefit from the medical therapy.

12. The method of claim 11, further comprising:
reducing the number of applicable individuals by a prevalence of individuals are able to access the medical therapy within the population who may benefit from the medical therapy to estimate a number of individuals within the human population who may benefit from the medical therapy and are able to access the medical therapy; and
outputting, by the computer system, an indication of the number of individuals within the human population who may benefit from the medical therapy and are able to access the medical therapy.

13. The method of claim 1, wherein outputting, by the computer system, an indication of the number of applicable individuals represents a number of individuals within the human population who may benefit from the medical therapy and are able to access the medical therapy.

14. The method of claim 1, further comprising:
querying, by the computer system, one or more users to input the indications of the plurality of attributes with the human population associated with the applicable individuals; and
for each respective attribute of the plurality attributes, querying, by the computer system, the one or more users to input the indication of the prevalence of the respective attribute.

15. The method of claim 1, further comprising receiving, with a computer system, for each respective attribute of the plurality attributes, an indication of a source that provides the indication of the prevalence of the respective attribute.

16. A computer system-readable storage medium that stores computer system-executable instructions that, when executed, configure a computer system to:
receive indications of a plurality of attributes associated with applicable individuals, wherein each respective one of the applicable individuals is a member of a human population and is a potential user of a medical therapy;
for each respective attribute of the plurality of attributes, receive a respective indication of a prevalence of the respective attribute;
estimate, based on the indications of the prevalence of the respective attributes, a number of applicable individuals; and
output the estimate of the number of the applicable individuals.

17. The computer system-readable storage medium of claim 16, wherein the computer system-executable instructions, when executed, further configure the computer system to output, for display, an indication tree that presents each of the plurality of attributes associated with applicable individuals within a hierarchy.

18. The computer system-readable storage medium of claim 17, wherein the indication tree further presents, for each respective attribute of the plurality of attributes, a value for the respective attribute, wherein the value for the respective attribute is an estimate of a number of individuals that are associated with the respective attribute and all other attributes at a dominant position within the hierarchy as compared to the respective attribute.

19. The computer system-readable storage medium of claim 17, wherein the instructions configure the computer system to output, for display, the estimate of the number of the applicable individuals within a box of the indication tree at a termination of a branch of the indication tree.

20. The computer system-readable storage medium of claim 16, wherein the computer system-executable instructions, when executed, further configure the computer system to:
associate the medical therapy with the estimate of the number of the applicable individuals; and
store, on a non-transitory computer-readable medium, an identification of the medical therapy and the estimate of the number of the applicable individuals.

21. The computer system-readable storage medium of claim 16, wherein estimating the number of the applicable individuals includes:
estimating the number of individuals within the human population who have a first attribute within the plurality of attributes; and
for each respective subsequent attribute within the plurality of attributes, reducing an estimate of the number of individuals within the human population who have each attribute previously accounted for, by an estimated prevalence of the subsequent attribute within a population of individuals who have each attribute previously accounted for,
wherein the reduced estimate following the accounting of the last attribute within the plurality of attributes represents the estimate of the number of applicable individuals.

22. The computer system-readable storage medium of claim 21, wherein the computer system-executable instructions, when executed, further configure the computer system such that, for each respective attribute within the plurality of attributes, the computer system outputs, for display, the reduced estimate of the number of individuals within the human population who have the respective attribute and each attribute previously accounted for.

23. The computer system-readable storage medium of claim 16, wherein the computer system-executable instructions, when executed, further configure the computer system to:
query one or more users to input the indications of the plurality of attributes with the human population associated with the applicable individuals; and
for each respective attribute of the plurality attributes, query the one or more users to input the indication of the prevalence of the respective attribute.

24. A computer system comprising one or more processors configured to:
receive indications of a plurality of attributes associated with applicable individuals, wherein each respective one of the applicable individuals is a member of a human population and is a potential user of a medical therapy;
for each respective attribute of the plurality of attributes, receive a respective indication of a prevalence of the respective attribute;
estimate, based on the indications of the prevalence of the respective attributes, a number of applicable individuals; and
present the estimate of the number of applicable individuals to a user.
